(19) United States
(12) Patent Application Publication
(10) Pub. No.: US 2015/0327331 A1
(43) Pub. Date: Nov. 12, 2015

(54) ADHESIVE AND HEATING ELEMENT LAMINATE FOR ATTACHING EVA PADDING

(71) Applicant: DISNEY ENTERPRISES, INC., Burbank, CA (US)

(72) Inventors: John Douglas Smith, Lake Buena Vista, FL (US); Laurel L. Skaggs, Orlando, FL (US); Mark A. Naylor, Minneola, FL (US)

(73) Assignee: DISNEY ENTERPRISES, INC., Burbank, CA (US)

(21) Appl. No.: 14/275,388

(22) Filed: May 12, 2014

(51) Int. Cl. H05B 3/03; B32B 37/18; B32B 38/00; B32B 37/06

(52) U.S. Cl. CPC H05B 3/03; B32B 37/06; B32B 37/182; B32B 38/0008

(57) ABSTRACT

A method for attaching padding material to a surface of a structural component, e.g., a lap bar or other park ride vehicle component. The method includes positioning a laminated sheet onto the surface of the structural component, with the laminated sheet including an adhesive material and a heating element. The method includes positioning a pad formed of the padding material onto the surface of the structural component, with a surface of the pad abuts an exposed surface of the laminated sheet. Further, the method involves connecting the heating element to a power source and then operating the power source to activate the heating element. The padding material may include ethylene vinyl acetate (EVA), and the adhesive material then is compatible with EVA. The adhesive material may be provided in first and second layers, and the heating element is sandwiched between the first and second layers in the laminated sheet.

### BACKGROUND

1. Field of the Description

The present invention relates, in general, adhesives for use with padding such as foam rubber padding and methods of attaching foam rubber padding onto mechanical structures such as lap bars of amusement park rides, and, more particularly, to methods of fabricating adhesive sheets or films for use with ethylene vinyl acetate (EVA or foam rubber), to methods of attaching EVA padding using these fabricated sheets or films to structural elements, and to structural elements covered with the adhesive sheets/films and EVA padding.

2. Relevant Background

One of the main design requirements for every amusement park ride is passenger safety. A related design goal is to create ride vehicles that are comfortable. To these two and other ends, ride designers have typically designed ride vehicles with rounded edges and surfaces. Further, many portions of the ride vehicle that the passengers may contact during the ride or while entering and exiting the ride vehicle have been covered with layers of padding. For example, many amusement park rides have vehicle in which a passenger restraint, such as a lap bar, is pulled toward the passenger and over their lap. During the ride, the passenger may come forward into the vehicle and with their stomach or legs pushed against the lap bar. To enhance passenger comfort as well as provide restraint for safety, the lap bar is covered with a soft pad or layer of soft padding.

The padding material use has varied over the years, but, more recently, many in the industry have begun to use ethylene vinyl acetate (EVA) in ride vehicles where it can readily be applied or attached. EVA, which is also popularly known as expanded rubber or foam rubber, is desirable in these applications because EVA is more durable than the many other materials that are used for padding and other soft goods. Further, EVA is a polymer that approaches elastomeric materials in softness and flexibility, and it is desirable because it has low-temperature toughness, stress-crack resistance, and resistance to ultraviolet (UV) radiation.

One limiting factor in the adoption of EVA padding is that it can be difficult to mount to or attach to many components of a ride vehicle. Other padding materials were often directly molded onto metal armatures, lap bars, and other parts. However, due to the manufacturing methods used to provide EVA padding sheets, it has not been possible to mold EVA directly onto the armatures and other ride vehicle components. Simple padding designs, therefore, have used mechanical fasteners to attach EVA padding to vehicle components. This may be useful for some components, but, for more complicated components such as cylindrical lap bars, mechanical fasteners have not proven to be effective or practical.

Some efforts have also been made to use adhesive to apply EVA padding to such components or vehicle surfaces. However, EVA-compatible adhesives generally require heat to set, and the levels of heat required often cause the EVA material to distort. In other cases, only inconsistent adhesion is obtained at the bond line such as when heat is applied from the padding side or exterior side of the padding.

Hence, there remains a need for methods of affixing EVA-padding to mechanical structures or components such as a cylindrical lap bar used in an amusement park ride vehicle and similar components. Preferably, these methods would allows the padding to be installed onto components of an already assembled vehicle, which is useful for replacing previously installed padding and in some manufacturing assembly settings.

### SUMMARY

Briefly, a method (and products made by the method) is taught for attaching or applying padding to a structural component. In some implementations, the padding is a thickness of a flexible and soft material such as EVA or foam rubber, and the structural component is a component of a ride vehicle such as a lap bar, a seat, a head rest, or a steering wheel. The padding attachment method utilizes an embedded heating element providing within a heat-activated adhesive, and, in some embodiments, laminated sheets (sometimes called “laminated film adhesive” or “laminated sheet adhesive,” herein) are provided for use in padding attachment that each includes a bottom layer of adhesive, a heating element layer, and a top layer of adhesive. The laminated sheet or film adhesive may be formed or manufactured in a number of ways including co-extrusion and compression molding, with the particular manufacturing method sometimes being selected depending upon the desired size of the laminate product.

The laminated sheet can then be cut to be in the shape or size of a particular pad or layer of padding. The sized and shaped laminated sheet can then be wrapped or placed onto a structural component, such as a cylindrical lap bar, and a pad or layer of padding (e.g., EVA padding) is positioned over the top of the structural component and the previously positioned laminated sheet (e.g., to sandwich the laminated sheet adhesive between the structural component and the EVA padding). After aligning the laminated sheet and the padding in a desired position/orientation, the heating element is energized or activated to supply heat and raise the temperature of the two adjacent layers of adhesive to temperatures required for proper setting of the adhesive material of the layers. This setting or curing temperature is held for a predefined time period, and, then, the heating element is de-energized or de-activated. The pad is now securely affixed to the structural component with uniform adhesion along the bond line and without deformation to the pad material.

More particularly, a method is provided for attaching padding material to a surface of a structural component (e.g., a lap bar armature). The method includes positioning a laminated sheet onto the surface of the structural component, with the laminated sheet including an adhesive material and a heating element. The method also includes positioning a pad formed of the padding material onto the surface of the structural component, with a surface of the pad abuts an exposed surface of the laminated sheet. Further, the method involves connecting the heating element to a power source and then operating the power source to activate the heating element.

In some implementations of the method, the padding material includes ethylene vinyl acetate (EVA) and the adhesive material is compatible with EVA and is heat cured. Further, the adhesive material may be provided in a first layer and a second layer, and, to perform the method, the heating element is sandwiched between the first and second layers in the laminated sheet. The laminated sheet may be formed with co-extrusion or compression molding of the first and second layers with the heating element disposed between the first and second layers.

In some cases, the heating element may take the form of a resistive heater (e.g., loops, coils, an interconnected mesh, or the like of copper wire) and the power source comprises an electrical power source passing current through the resistive heater. The operating of the power source step may include heating the heating element to a temperature within a curing range for the adhesive material. In such cases, operating the power source further can include operating the heating element at the temperature in the curing range for a curing time for the adhesive material.

### BRIEF DESCRIPTION OF THE DRAWINGS

FIG. 1 illustrates a top view of a laminated sheet (or laminated product or laminated adhesive film or sheet) of the present description;

FIG. 2 illustrates a sectional view of the laminated sheet of FIG. 1 taken at line 2-2;

FIG. 3 illustrates an enlarged, partial view of the sectional view of the laminated sheet of FIG. 2;

FIG. 4 is a flow diagram for a method of fabricating a laminated sheet adhesive such as the sheet shown in FIGS. 1-3;

FIG. 5 is a side view of a padded structural assembly or apparatus including a lap bar (or lap bar armature) (i.e., a structural component) and padding that has been attached using the laminated sheet adhesive of the present description;

FIG. 6 is another side view of the assembly of FIG. 5 with a portion of the padding removed to reveal the underlying laminated sheet adhesive used to attach the padding to the exterior surfaces of the lap bar; and

FIG. 7 is a flow diagram for a method of attaching padding to a structural component as described herein and as may be used with the assembly of FIGS. 5 and 6.

### DETAILED DESCRIPTION

Briefly, a padding attachment method (and resulting products) is described herein that is specially adapted to use an embedded heating element in heat-activated film adhesive. The method includes, in some cases, fabricating or providing laminated sheets (sometimes called “laminated film adhesive” or “laminated sheet adhesive,” herein) for use in padding attachment, and each of these laminated sheets includes a bottom layer of adhesive, a heating element layer, and a top layer of adhesive. The laminated sheet or laminated film adhesive may be formed or manufactured in a number of ways including co-extrusion and compression molding. After aligning the laminated sheet and the padding in a desired position/orientation, the heating element is energized or activated to supply heat and raise the temperature of the two adjacent layers of adhesive to temperatures required for proper setting of the adhesive material of the layers. This setting or curing temperature is held for a predefined time period, and, then, the heating element is de-energized or de-activated.

It was determined by the inventors that the method or process should be designed to meet all or some of the following criteria: (a) include heat-activated film adhesive with embedded heating element; (b) provided an adhesive assembly or laminated sheet that is flexible and sizeable to meet a variety of applications (e.g., to wrap around a cylindrical lap bar and so on); (c) be able to distribute heat uniformly with the heating element; (d) provide enough heat to reach film adhesive's cure temperatures; and (e) be able to control and regulate heat distribution during adhesive curing step.

With these and other design parameters in mind, the present description teaches a bonding design that provides a heating element sandwiched between two layers of film adhesive. In some cases, the heating element is connected to an external power source, e.g., the heating element may be formed of copper wire/mesh and may act as a resistive heating element when current is passed through from an electrical power source but in other cases the power source may be hot gas or liquid controllers that regulate flow of gas/liquid through tubing/flow channels laminated between two layers of adhesive film. The external power source is turned on/activated to cause sufficient heat to be generated by the heating element to cure the two layers of adhesive film laminated together with the heating element.

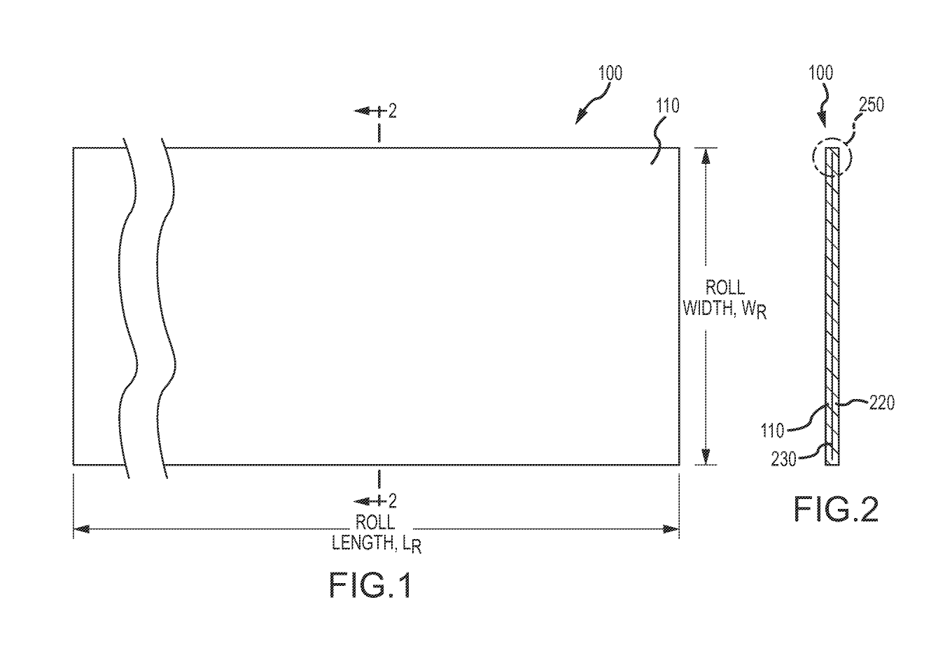

FIG. 1 illustrates a laminated sheet 100 of the present description as may be formed using techniques such as co-extrusion or compression molding. The laminated sheet 100 has a first layer of adhesive 110 that can be seen in FIG. 1, and the laminated sheet 100 can be provided in a roll to have a desired length, L_{R}, and width, W_{R} (e.g., a roll may be several-to-many feet in length and have a width of several inches to several feet in many applications such as when co-extrusion is used to form the laminated sheet 100).

FIG. 2 is a sectional view of the laminated sheet 100. Significantly, the laminated sheet 100 includes three layers or parts that are combined or laminated together. As shown, the laminated sheet 100 includes the first layer (or top layer) of film adhesive 110 and a second layer (or bottom layer) of film adhesive 220. Sandwiched between these two film adhesive layers 110, 220 is a heating element 230, which as discussed herein can be used to heat the layers 110, 220 up to temperatures within the curing temperature range of the material in the layers 110, 220.

The adhesive layers 110, 230 may take a number of forms to implement or practice the laminated sheet 100, and the particular adhesive or adhesive material used will be chosen to be compatible with a padding material (e.g., EVA or other desirable padding material) and to be heat curing materials that have a curing temperature range that can be achieved with an embedded heating element. For example when EVA is used with the laminated sheet, the adhesive films or layers 110, 230 may take the form of heat-curing, thermoplastic films that can be readily co-extruded with each other and laminated to the heating element 230. In some cases, the thermoplastic films may have compositions such as thermnoplastic polyurethane (TPU), ester TPU, nylon and/or polyamide, polyester, and ethylene acrylate. The curing (or setting) temperature range may also vary depending on which adhesive material is used to provide the layers/films 110, 230, with some implementations having curing temperature ranges in the larger range of about 75° C. to 200° C. with the particular range not being limiting of the description as long as the heating element is adapted to heat the layers 110, 230 to a temperature within the curing range.

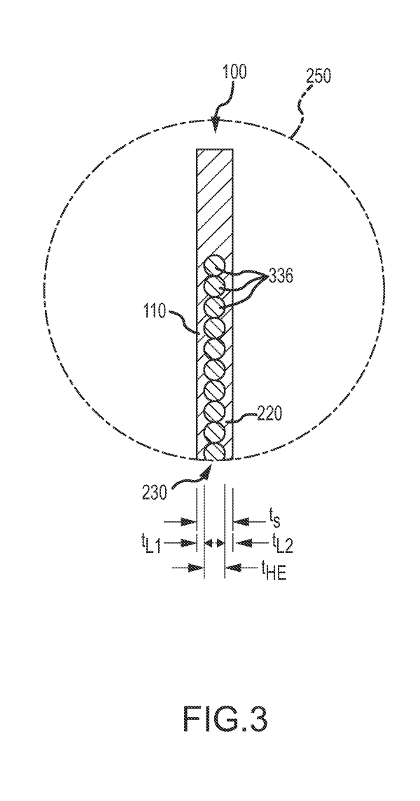

FIG. 3 is an enlarged partial view of the cross-section provided in FIG. 2 of the laminated sheet 100. FIG. 3 is useful for more clearly showing the makeup of the laminated sheet 110 including one useful implementation of a heating element 230. As shown, the laminated sheet 100 includes the first layer of adhesive film 110, a heating element 230, and a second layer of adhesive film 220. The heating element 230 is formed from wire, such as copper wire or other metal wire that generates heat when electric current flows through it (i.e., a resistive heat element), with FIG. 3 showing sections 336 of a plurality of loops or runs of the wire. Typically, a single run of wire may be used and arranged in a looped pattern (wire bent to pass back and forth by other loops or runs of the same wire so as to provide a wire sheet) with little to no spacing (as shown in FIG. 3) between runs 336 of the wire heating element 230 or with a relatively small spacing that may be filled with adhesive material from layer 110 or layer 220. In other cases, a number of interconnected wires 336 may be combined, into a tightly woven mesh sheet or the like, to provide the heating element 230.

As shown, the laminated sheet 100 provides a heating element 230 that is embedded, not generally exposed, within the two adhesive layers 110, 220. The laminated sheet 100 has an overall thickness, t_{S}, that is defined by the combination of the thickness, t_{L1}, of the first layer 110, the thickness, t_{HE}, of the heating element 230 (or diameter of wire(s) 336), and the thickness, t_{L2}, of the second layer 220. In some embodiments, the laminated sheet thickness, t_{S}, is in the range of 2 to 10 mils, and the thicknesses, t_{L1} and t_{L2}, are often equal and chosen to fully cover or embed the heating element 230 and to provide adequate bonding of padding to a structural component (e.g., the diameter of the wire may be 5 mils and each layer of the adhesive may be 2 mils for a total thickness of 9 mils).

The heating element 230 made of copper or other wire may also be replaced with other types of heating elements useful for heating adhesive material of layers 110, 220 to the curing temperature. For example, other metals or composites provides in wire or other forms (e.g., a thin mesh or solid sheet) can be used to provide resistive heat elements that generate heat when current is passed through them with an electrical power source.

In other embodiments, the heating element is not a resistive-type heater. Instead, metallic tubing or a channel plate may be used to distribute a volume of flowing hot liquid or gas through the two layers of adhesive material. In this embodiment, a fluid flow manifold would be connected to an open end of the tubing (or one or more of the channel inlets) and be controlled to provide a desired flow while a discharge manifold may be provided at a second, oppositely-located open end of the tubing (or one or more of the channel outlets). The sidewalls of the metal tubing/channels would be heated by the flowing gas or liquid and, in response, conductively heat the surrounding adhesive material to its curing temperature.

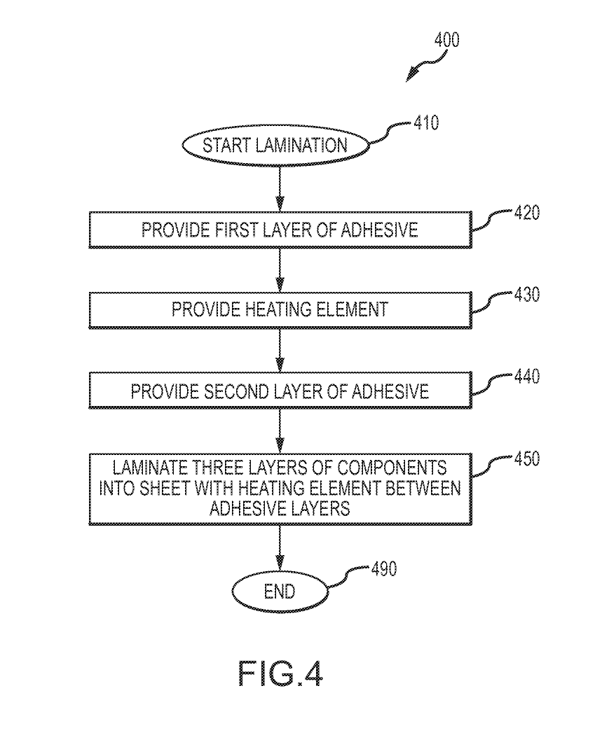

FIG. 4 illustrates a method 400 of fabricating a laminated sheet (or laminated sheet adhesive) such as the sheet 100 of FIGS. 1-3. The method 400 begins at 410 such as with a selection of adhesive materials for use in a laminated sheet and selection of a heating element design (resistive wiring heater or hot gas/liquid tubing heater). The selection of adhesive materials typically involves choosing an adhesive that is useful both with the padding or pad material to be applied to a mechanical structure and also with the exposed material of the mechanical structure. In some cases, EVA is used for the padding and the mechanical structure is a metal (e.g., a steel), and the adhesive would be chosen to be compatible with these materials (which typically results in the adhesive being a heat cured adhesive file such as an ester TPU or the like as discussed above with regard to layers 110, 220 of sheet 100).

The method 400 continues at step 420 with providing a first layer of the adhesive material chosen in step 410, at step 430 with providing a heat element with the design chosen in step 410, and at step 440 with providing a second layer of the adhesive material. Then, the method 400 continues at step 450 with laminating the three layers (or sheet components) together to form a single sheet with the heating element sandwiched between the two adhesive material layers so as to provide an adhesive sheet with an embedded heating element. The method 400 may then end at step 490.

In some cases, step 450 is carried out with compression molding. In other implementations of the method 400, step 450 involves co-extrusion of the three components or layers of the adhesive sheet, and, in such embodiments, steps 420-450 are typically performed concurrently with extruded adhesive films being extruded over opposite sides of the heating element to provide the laminated sheet. The laminated sheet may be produced in rolls, as discussed with reference to FIG. 1, and then cut into desired shapes with particular dimensions/sizes (with this step performnned before or after step 490) or in separate sheets of a desired size and shape (such as when compression molding is utilized for step 450).

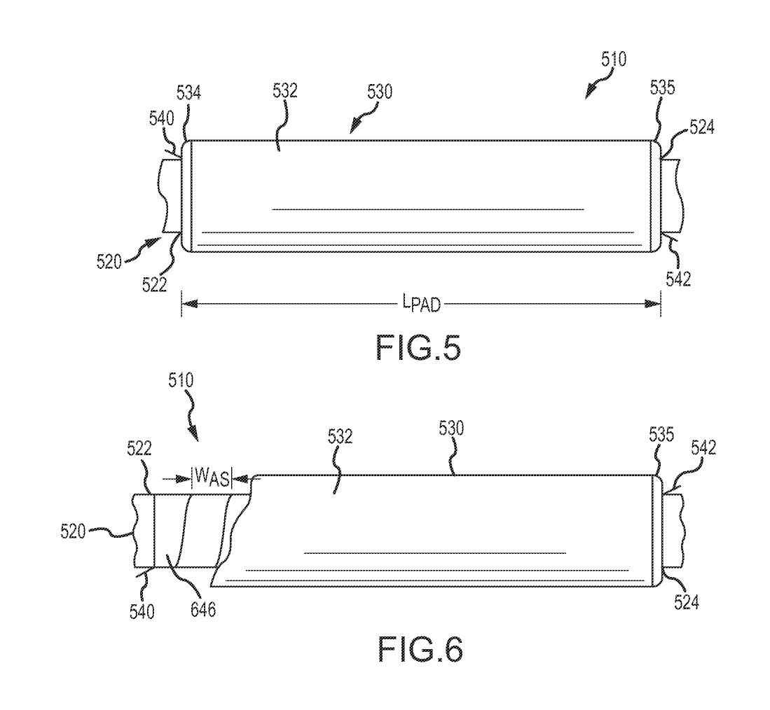

FIG. 5 is a padded structural assembly or apparatus 510 including a lap bar (or lap bar armature) (i.e., a structural component) 520 and padding 530 that has been attached using the laminated sheet adhesive of the present description (not viewable in FIG. 5 but shown in FIG. 6). As shown, the assembly 510 includes a structural component in the form of a lap bar armature 520 that is cylindrical in shape and that may be difficult to apply padding to in place (e.g., within a fabricated and, in some cases, installed ride vehicle). Further, FIG. 5 shows that the assembly 510 includes padding 530 that has been attached over an exterior surface of the lap bar 520 from a first location 522 to a second location 524 on the surface of the lap bar 520 such that the padding 530 had a desired length, L_{Pad}, and covers a desired portion of the lap bar 520 (such as where passengers may come into contact with the lap bar 520).

As assembled and attached, the padding 530 includes a first or exterior surface 532 facing outward or away from the lap bar 520 (i.e., is distal to the exterior surface of the lap bar 520). The padding 530 also includes a second or interior surface not visible in FIG. 5 that is facing inward or toward the lap bar 520 (i.e., is proximate to the exterior surface of the lap bar 520). The second or interior surface or side of the padding 530 is positioned to abut and mate with a laminated sheet, formed of two adhesive film layers (e.g., heat-cured adhesive material such as for use with EVA) with a heating element sandwiched there between (e.g., the heating element is embedded in the adhesive material), that has been positioned over the lap bar surface from location 522 to location 524 (a portion of which is visible in FIG. 6).

The padding 530 extends from a first end/edge 534 aligned with the first location 522 on the lap bar 520 to a second end/edge 535 aligned with the second location 524 on the lap bar 520. Further, the assembly 510 includes (at least temporarily) a pair of heating element connectors 540, 542 that extend outward from the padding ends/edges 534, 535, respectively, to facilitate their connection to a power source (such as an electrical power source for driving a resistive heating element) (not shown but well understood by those skilled in the art). In this manner, the laminated sheet can be heated via the power source activating the embedded heating element to a curing temperature of the adhesive material such that the adhesive is heated from within rather than from a heat source applied over the surface 532 of the padding 530, which can cause deformation of the padding 530 or can fail to achieve a uniform bonding at the bond line on the lap bar 520.

Turning now to FIG. 6, the assembly 510 is shown with a portion of the padding 530 removed so as to reveal a laminated sheet 646 from which the heating element connectors 540, 542 extend. The laminated sheet 646 may take any of the forms described herein, such as those shown in FIGS. 1-3, to include an upper adhesive layer, a heating element, and a lower adhesive layer. In the implementation of FIG. 6, the laminated sheet (or adhesive sheet) 646 has been cut into strips or to have a relatively small width, W_{AS}, such as 1 to 6 inches or the like as compared to its length.

The laminated sheet 646 has been positioned over the exterior surface of the lap bar 520 by wrapping (generally, in a single sheet thickness) its length around the cylindrical lap bar 520 from location 522 to location 524. An exterior or upper surface of the upper adhesive layer of the sheet 646 is exposed and abuts and mates with a second or interior surface of the padding 530, and a lower or exterior surface of the lower adhesive layer of the sheet is exposed and abuts and mates with the exterior surface of the lap bar 520. The connectors 540, 542 are left exposed and extend out past the padding end points/locations 522, 524 on the lap bar 520. In practice, with the adhesive sheet 646 in place and aligned, the padding 530 is then positioned over the sheet 646, the connectors 540, 542 are connected to a power source (not shown), the power source is operated to activate the heating element to raise it to a temperature within the curing temperature range of the adhesive material in the sheet 646 for a curing time, and then the power source is disconnected and, optionally, the connectors 540, 542 may be removed from the assembly 510.

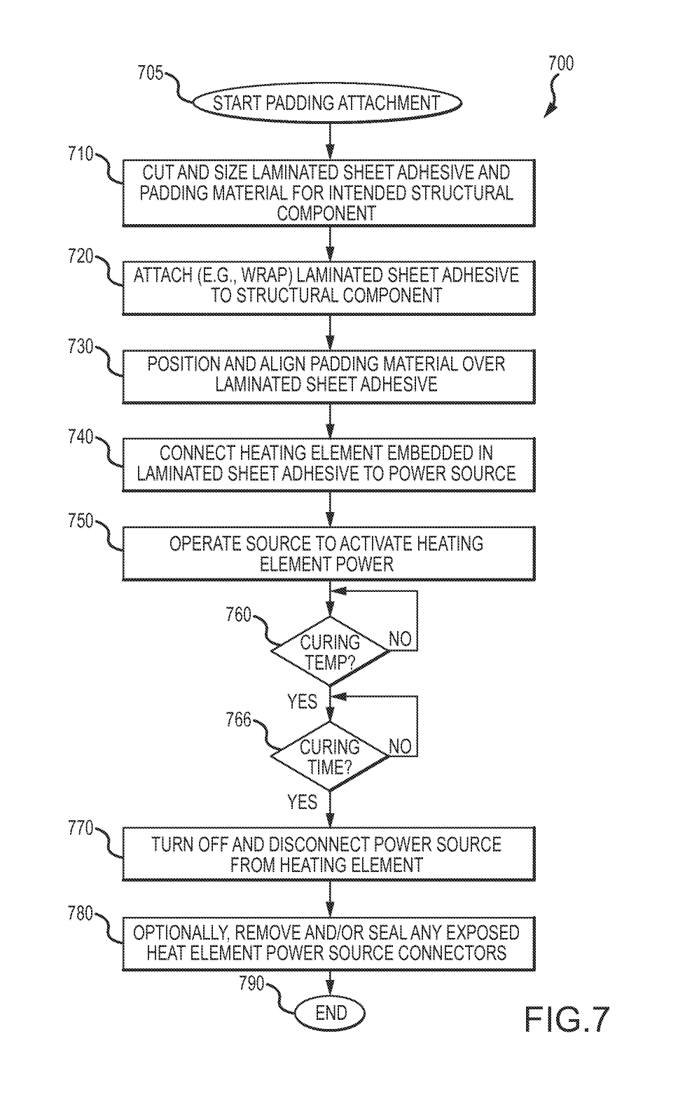

FIG. 7 illustrates with a flow diagram a method 700 for attaching padding material such as EVA to a structural component (or a surface of such a component). The method 700 begins at 705 such as by identifying a structural component to pad, selecting a padding material (and its thickness), and selecting both an adhesive material to use with the padding material (e.g., a heat-cured adhesive film compatible with the padding material such as EVA) and a heating element to use with and embed within the adhesive material. This selected adhesive and heating element may then be fabricated into a laminated sheet (or laminated sheet adhesive) as shown in the method of FIG. 4.

The method 700 continues at step 710 with cutting and sizing the laminated sheet adhesive for application over surfaces of the structural component. For example, a large sheet may be cut into strips to wrap around a cylindrical, a square, a triangular, or other bar or the sheet may be cut into a particular shape or size to match the size and shape of the surface to be padded (to match the padding size and shape). In step 710, the padding material, such as a sheet of EVA or the like, is also cut or otherwise processed to have the shape and size of the surface to be padded, e.g., in a tubular form to apply to a lap bar or steering wheel. In step 720, the laminated sheet that was sized and shaped in steps 710 is positioned and temporarily attached (as needed) to the surface of the structural component.

In step 730, the method 700 involves positioning and aligning the sized and shaped padding material over the laminated sheet (and structural component surface). In step 740, the method 700 continues with connecting or coupling a power source to the heating element embedded within the two layers or films of adhesive material in the laminated sheet. When the heating element is an electrical resistive heater (e.g., a mesh or coil of copper wire or the like), step 740 involves attaching electrical connectors from an electrical power source to electrical connectors of the heating element (e.g., extending outward from the padding material). When the heating element is a conductive heater, step 740 can involve fluidically coupling an outlet of a hot gas or liquid source to an inlet of the heating element extending out fiom or accessible at edges of the padding and fluidically coupling an outlet of the heating element to a drain or discharge line (or an inlet to the power source for reheating).

Step 750 is then performed which includes operating (turning on) the power source so as to activate the heating element. Activation may involve heating a resistive heater by passing current through its wires or sheets or involve heating walls of heat-conductive tubing or fluid channels. The heated or activated heating element, due to its embedded position, passes this heat into the nearby adhesive material. The heating element is configured to provide relatively uniform heating of the adjacent adhesive as it has the same shape and size as the adhesive films it is sandwiched between in the laminated sheet adhesive.

In step 760, the method 700 involves waiting for a curing temperature (a temperature within a curing temperature range for the adhesive material) to be reached, e.g., a time for reaching this temperature may be determined for the heating element prior to its being embedded within the adhesive films/layers. At step 766, the power source is operated to maintain the heating element at the curing temperature for a curing time for the adhesive material in the laminated sheet. At step 770, the method 700 continues with turning off the power source and disconnecting the power source from the embedded heating element. Then, in step 780 (which is optional), the power source connectors on the heating element may be removed or sealed off. The method 700 may then end at 790 with the padding material being attached to the structure component's surface with a unifonn bonding provided by the cured adhesive material of the laminated sheet (and without deformation of the padding material).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for attaching padding material to a surface of a structural component, comprising:
positioning a laminated sheet onto the surface of the structural component, wherein the laminated sheet comprises adhesive material and a heating element;
positioning a pad formed of the padding material onto the surface of the structural component, wherein a surface of the pad abuts an exposed surface of the laminated sheet;
connecting the heating element to a power source; and
operating the power source to activate the heating element.

2. The method of claim 1, wherein the padding material comprises ethylene vinyl acetate (EVA) and the adhesive material is compatible with EVA and is heat cured.

3. The method of claim 1, wherein the adhesive material is provided in a first layer and a second layer and wherein the heating element is sandwiched between the first and second layers in the laminated sheet.

4. The method of claim 3, wherein the laminated sheet is formed with co-extrusion or compression molding of the first and second layers with the heating element disposed between the first and second layers.

5. The method of claim 3, wherein the heating element comprises a resistive heater and the power source comprises an electrical power source passing current through the resistive heater.

6. The method of claim 5, wherein the resistive heater comprises copper wire.

7. The method of claim 1, wherein the operating of the power source comprises heating the heating element to a temperature within a curing range for the adhesive material.

8. The method of claim 7, wherein the operating of the power source further comprises operating the heating element at the temperature in the curing range for a curing time for the adhesive material.

9. An assembly for use in applying ethylene vinyl acetate (EVA) to a surface of a structural component, comprising:
a first layer of adhesive material that is cured by heating to temperatures in a curing temperature range;
a heating element; and
a second layer of the adhesive material,
wherein the first and second layers are laminated together with the heating element disposed therebetween and
wherein the heating element is operable to concurrently heat the first and second layers of the adhesive material to a temperature in the curing temperature range.

10. The assembly of claim 9, wherein the heating element comprises a resistive heater formed of metal wire and a pair of power source connectors formed of the metal wire extend outward from the adhesive material.

11. The assembly of claim 9, wherein the heating element comprises metal tubing or flow channels for receiving hot gas or liquid.

12. The assembly of claim 9, wherein the first and second layers are laminated into a sheet embedding the heating element in the adhesive material.

13. The assembly of claim 12, wherein the laminated sheet is formed using co-extrusion or compression molding.

14. The assembly of claim 9, wherein the adhesive material is heat cured and compatible with EVA.

15. The assembly of claim 14, wherein a deformation temperature of EVA falls within the curing temperature ranges for the adhesive material.

16. A method for attaching padding material comprising:
providing a laminated sheet comprising a first layer of ethylene vinyl acetate (EVA)-compatible adhesive, a second layer of the EVA-compatible adhesive, and a heating element between the first and second layers of the EVA-compatible adhesive;
positioning the laminated sheet onto a surface of a structural component with an exposed surface of the second layer of the EVA-compatible adhesive abutting the surface of the structural component; and
positioning a pad formed of the padding material onto the surface of the structural component,
wherein a surface of the pad abuts an exposed surface of first layer of the EVA-compatible adhesive of the laminated sheet.

17. The method of claim 16, further comprising:
connecting the heating element to a power source; and
operating the power source to activate the heating element.

18. The method of claim 16, wherein the laminated sheet is fonned with co-extrusion or compression molding of the first and second layers with the heating element disposed between the first and second layers.

19. The method of claim 16, wherein the heating element comprises a resistive heater and the power source comprises an electrical power source passing current through the resistive heater.

20. The method of claim 1, wherein the operating of the power source comprises heating the heating element to a temperature within a curing range for the adhesive material and further comprises operating the heating element at the temperature in the curing range for a curing time for the adhesive material.
